(19) United States
(12) Patent Application Publication
(10) Pub. No.: US 2024/0062146 A1
(43) Pub. Date: Feb. 22, 2024

(54) HYBRID SYSTEM FOR MULTI-ORDER BATCHING WITH REAL-TIME AND ITEM AWARENESS

(71) Applicant: Uber Technologies, Inc., San Francisco, CA (US)

(72) Inventors: Robert Louis Cornacchia, New York, NY (US); Stephan Liu, New York, NY (US); Vishnu Sundaresan, Fremont, CA (US); Ameya Tayade, White Plains, NY (US); Sam Wechsler, New York, NY (US); Justin Wie, New York, NY (US)

(21) Appl. No.: 17/889,070

(22) Filed: Aug. 16, 2022

(51) Int. Cl. G06Q 10/08

(52) U.S. Cl. CPC G06Q 10/08355

(57) ABSTRACT

Example aspects of the present disclosure relate to a hybrid approach for scheduling delivery services that seamlessly integrates real-time courier matching with pre-matching batch analysis to optimize courier time. An example method includes accessing delivery data for a subset of a plurality of delivery services that are available for batch delivery assessment. The method includes generating a batched route for at least two delivery services of the subset of delivery services based on the delivery data. The method includes detecting a state change that is associated with a delivery service of the batched route. In response to the state change, the method includes accessing real-time vehicle data indicative of an availability of one or more vehicles and communicating data indicative of the batched route to at least one vehicle of the plurality of vehicles.

### FIELD

The present disclosure generally relates to dynamically routing real-time services.

### BACKGROUND

Delivery services can be performed in real-time or can be precomputed for a future instance. For instance, a user may request, through a delivery service application, a delivery to be performed in real-time such as, for example, to deliver a perishable food item. In addition, a user may request, through the delivery service application, a delivery to be performed in the near future such as, for example, to deliver non-perishable items. Courier efficiency may be improved by routing a courier along a batched route to simultaneously perform both real-time and batched deliveries.

### SUMMARY

Aspects and advantages of embodiments of the present disclosure will be set forth in part in the following description, or may be learned from the description, or may be learned through practice of the embodiments.

One example aspect of the present disclosure is directed to a computing system. The computing system includes one or more processors and one or more tangible, non-transitory, computer-readable media that store instructions that are executable by the one or more processors to cause the computing system to perform operations. The operations include accessing, based on state data for a plurality of delivery services, delivery data indicative of a plurality of delivery attributes for at least a subset of the plurality of delivery services that are available for batch delivery assessment. The operations include generating a batched route for at least two delivery services of the subset of delivery services based on the delivery data. The batched route includes one or more pick-up locations and a plurality of destination locations corresponding to the at least two delivery services. The operations include updating, based on the batched route, a service queue including a plurality of precomputed routes associated with the subset of delivery services. The operations include detecting, based on the state data, a state change that is associated with a delivery service associated with the batched route. The operations include, in response to the state change, accessing real-time vehicle data indicative of an availability of one or more vehicles. The operations include communicating, based on the real-time vehicle data, data indicative of the batched route to at least one vehicle of the plurality of vehicles.

Another example aspect of the present disclosure is directed to a computer-implemented method. The method includes accessing, based on state data for a plurality of delivery services, delivery data indicative of a plurality of delivery attributes for at least a subset of the plurality of delivery services that are available for batch delivery assessment. The method includes generating a batched route for at least two delivery services of the subset of delivery services based on the delivery data. The batched route includes one or more pick-up locations and a plurality of destination locations corresponding to the at least two delivery services. The method includes updating, based on the batched route, a service queue including a plurality of precomputed routes associated with the subset of delivery services. The method includes detecting, based on the state data, a state change that is associated with a delivery service associated with the batched route. The method includes, in response to the state change, accessing real-time vehicle data indicative of an availability of one or more vehicles. The method includes communicating, based on the real-time vehicle data, data indicative of the batched route to at least one vehicle of the plurality of vehicles.

Yet another example aspect of the present disclosure is directed to one or more non-transitory computer readable media storing instructions that are executable by one or more processors to perform operations. The operations include accessing, based on state data for a plurality of delivery services, delivery data indicative of a plurality of delivery attributes for at least a subset of the plurality of delivery services that are available for batch delivery assessment. The operations include generating a batched route for at least two delivery services of the subset of delivery services based on the delivery data. The batched route includes one or more pick-up locations and a plurality of destination locations corresponding to the at least two delivery services. The operations include updating, based on the batched route, a service queue including a plurality of precomputed routes associated with the subset of delivery services. The operations include detecting, based on the state data, a state change that is associated with a delivery service associated with the batched route. The operations include, in response to the state change, accessing real-time vehicle data indicative of an availability of one or more vehicles. The operations include communicating, based on the real-time vehicle data, data indicative of the batched route to at least one vehicle of the plurality of vehicles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system according to aspects of the present disclosure.

FIG. 2 depicts a block diagram for a hybrid delivery system according to aspects of the present disclosure.

FIG. 3 depicts a state diagram for a delivery service according to example embodiments of the present disclosure.

FIG. 4 depicts an interactive user interface according to example embodiments of the present disclosure.

FIG. 5 depicts a data flow diagram for a hybrid delivery system according to aspects of the present disclosure.

FIG. 6 depicts a flowchart of an example method for a hybrid delivery approach according to example embodiments of the present disclosure.

FIG. 7 depicts a flowchart of an example method for generating a plurality of batched routes according to example embodiments of the present disclosure.

FIG. 8 depicts a flowchart of an example method according to example embodiments of the present disclosure.

FIGS. 9 and 10 depict block diagrams of example systems according to example embodiments of the present disclosure.

### DETAILED DESCRIPTION

Generally, the present disclosure is directed to a hybrid approach for scheduling delivery services that seamlessly integrates real-time courier matching with pre-matching batch analysis to improve courier efficiency. For instance, a computing system can receive a plurality of requests for the performance of delivery services. The computing system can assign a state to each request based on a requested delivery time, delivery window, and/or a perishability of the item to be delivered. The state of a requested delivery service can identify: (i) whether the requested delivery service is eligible for pre-matching batch delivery analysis; and (ii) a current phase (e.g., a batching phase, assignment phase, assigned phase, etc.) of the requested delivery service in the overall scheduling process. At a regular time interval, the computing system can analyze a subset of a plurality of requested delivery services that are eligible for the pre-matching batch delivery analysis to group the delivery services into a plurality of batched routes. A batched route can include a route with multiple pick-up/drop-off locations associated with the performance of at least two of the delivery services with one courier. The batched routes can be continually evaluated based on route characteristics (e.g., pick-up/drop-off locations, etc.) and item characteristics (e.g., size, weight, dimensions, etc.) associated with the delivery services to lower the aggregate courier time for performing the delivery services.

When a delivery time for a delivery service in a batched route approaches the current time, the computing system can change the state for each requested delivery service of the batched route to reflect an assignment phase of the overall scheduling process. During the assignment phase, the computing system can provide information associated with the batched route to couriers that are available in real-time. In this manner, the computing system can continually optimize routes up to the requested delivery time of a respective delivery service and reliably match a batched route to a courier in real-time. Moreover, a batched route can be provided to a courier that is performing another delivery or passenger transportation service. For instance, to further improve courier time, a batched route that shares similarities with a real-time delivery service (e.g., for a perishable food item) can be provided to a courier assigned to perform the real-time delivery service.

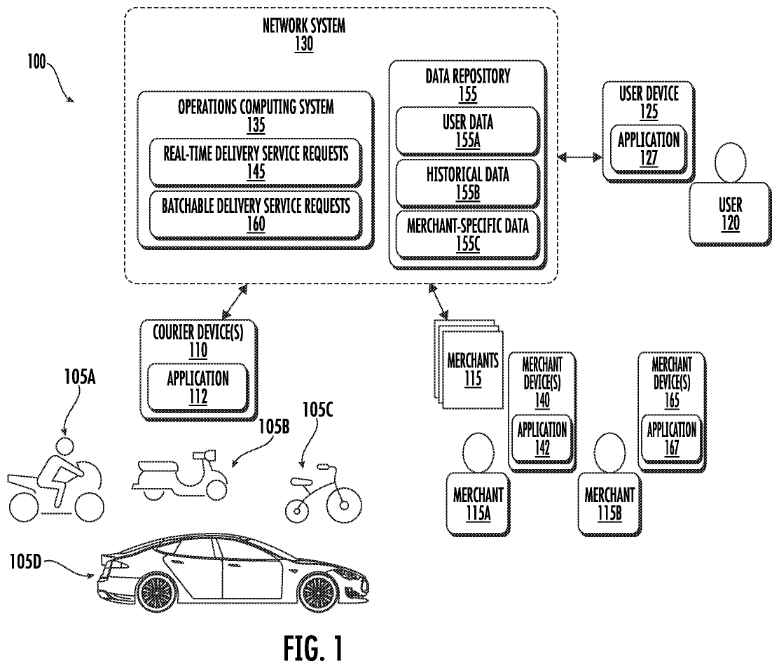

FIG. 1 depicts a block diagram of an example system 100 according to aspects of the present disclosure. As illustrated, FIG. 1 shows a system 100 that can include one or more vehicles 105A-D (e.g., a car, scooter, motorcycle, bicycle) and one or more courier devices 110 that can be associated with one or more couriers which can operate the one or more vehicles 105A-D. In some examples, the one or more couriers are humans. In some examples, the courier(s) can be non-human (e.g., vehicle, autonomous vehicle, autonomous robot).

The one or more couriers and the one or more courier devices 110 (e.g., an onboard tablet, a mobile device of a courier) can be associated with the one or more vehicles 105A-D. The courier device(s) 110 can include a software application 112 associated with a delivery service entity, which can run on the courier device(s) 110.

The system 100 can include one or more merchants 115. The merchants 115 can receive data indicative of a delivery service request from a user 120. For example, the user 120 can submit a request through a user device 125 associated with the user (e.g., via a software application 127).

A network system 130 can comprise a computing system associated with a service entity that can facilitate a request for services from the user 120. An operations computing system 135 associated with the delivery service entity can facilitate a request for services from the user 120.

For example, the user 120 can submit a delivery request through a user device 125 associated with the user 120 (e.g., via a software application 127). Operations computing system 135 can receive delivery service requests for a plurality of delivery services from a user device 125. The plurality delivery services can be associated with timing information. For example, real-time delivery service requests 145 can request that the service be performed within a short period of time after transmittal of the real-time delivery service request. This can include the performance of a real-time delivery service within a threshold time from submission of the real-time delivery service requests 145 to the network system 130 or another device.

Batchable delivery service requests 160 can request the performance of a delivery service within a future time range of the batchable delivery service requests 160. In some implementations, the real-time delivery service requests 145 can be for perishable items and the batchable delivery service requests 160 can be for non-perishable items.

The operations computing system 135 can send data indicative of a delivery service request to a merchant device 140 associated with a merchant 115A (e.g., via a software application 142). The operations computing system 135 can receive data indicative of a merchant 115A accepting the delivery service request. The operations computing system can send a request to a courier device 110 associated with the courier to complete the delivery service request (e.g., via application 112).

The network system 130 can include a data repository 155. The data repository 155 can include user data 155A (e.g., data associated with user 120), historical data 155B (e.g., data associated with user 120, data associated with merchant(s) 115, data associated with couriers), merchant-specific data 155C (e.g., real-time data associated with merchants 115), and/or any other relevant data (e.g., system-level data associated with a plurality of users, expected demand).

The operations computing system 135 can generate data indicative of the delivery service requests and can provide data for display on a user device 125 (e.g., via application 127) indicative of updates on the delivery service request. For example, an update can include an update about what stage of delivery the delivery service is in (e.g., preparation, pick-up by courier, courier in route, approaching delivery, delivered).

The operations computing system 135 associated with the service entity can receive a delivery service request from the user device 125. The operations computing system 135 can send a request to a courier device 110 associated with a courier (e.g., via a software application 112) for the courier to perform the requested primary order request service. The courier can be associated with the vehicle (e.g., vehicle 105A-D).

The operations computing system can communicate data indicative of the delivery service request to a courier (e.g., a human courier, an autonomous vehicle courier, an autonomous robot courier). For instance, the operations computing system 135 can send a request to the courier device 110 of the courier. Additionally, or alternatively, the operations computing system 135 can send a request to a courier device(s) 110 (e.g., a tablet stored onboard the vehicle) of at least one of vehicles 105A-D. The request can be communicated to the courier via the software application 112 running on the courier device 110 associated with the courier.

A courier can provide user input to the courier device 110 (e.g., via the software application 112) to accept or decline the vehicle service request. In some examples, user input can be provided directly into a service application (e.g., via a user interface element). Additionally, or alternatively, user input can be provided via an application programing interface (API) and/or a third-party application. Data indicative of the acceptance or rejection of the request can be provided to the operations computing system 135.

The systems of FIG. 1 can create a hybrid approach for scheduling delivery services that seamlessly integrates real-time courier matching with pre-matching batch analysis to optimize courier time.

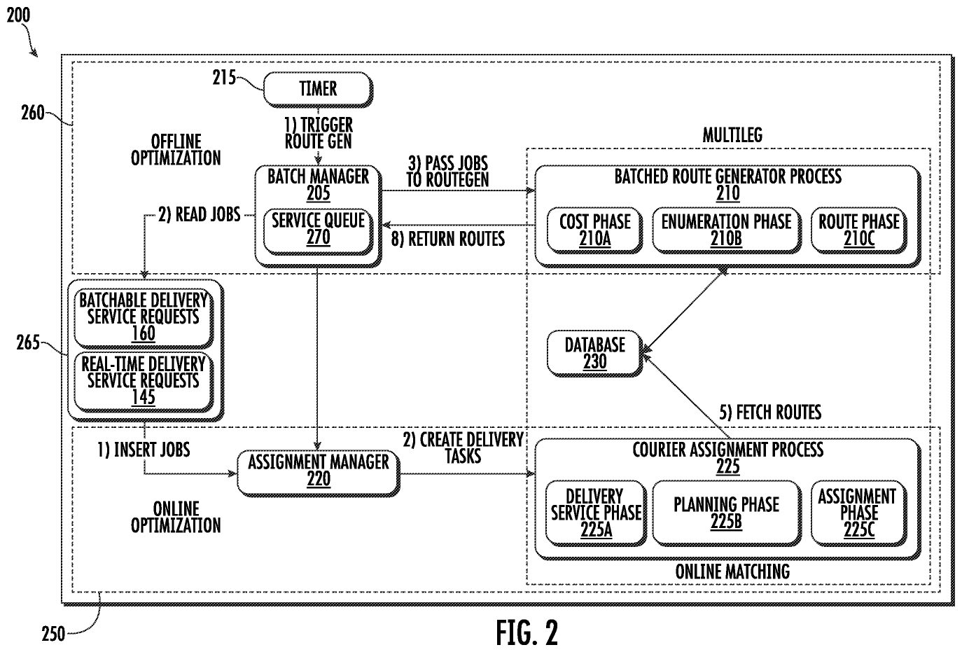

FIG. 2 depicts a block diagram for a hybrid delivery system 200 according to aspects of the present disclosure. The hybrid delivery system 200 can include a plurality of subsystems, software modules, and/or computing tools that enable the implementation of a hybrid delivery service that integrates a real-time courier matching process 250 with a pre-matching batch analysis process 260.

The pre-matching batch analysis process 260 can include a vertical-agnostic matching solution that can generate batched routes of a plurality of device services. This can include, for example, five to upwards of ten delivery services. The hybrid delivery system 200 can combine the real-time courier matching process 250 with a pre-matching batch analysis process 260 for an ensemble approach of route generation.

The pre-matching batch analysis process 260 can provide a number of computational improvements and technical effects. The pre-matching batch analysis process 260 may be implemented as an offline process to avoid unnecessary computational complexity associated with generating batched routes and allow the hybrid delivery system 200 more compute time to generate and select a plurality of batched routes for eligible delivery requests. As such, the technology of the present disclosure can help reduce the number of computational resources (and improve computational efficiency) for generating batched routes for a large number of delivery services.

Moreover, by introducing the pre-matching batch analysis process 260 as an offline flow, the hybrid delivery system 200 can allow more compute time (up to 15 minutes rather than less than 30 seconds) to generate and select a plurality of batched routes for eligible delivery requests. The batched routes can be cached and merged into the real-time courier matching process 250 when it comes time to dispatch the couriers to complete the delivery services. This can lead to more efficient courier routing as well as less courier downtime, improving fuel consumption and reducing the computational resources used on the courier device that may otherwise be used for inefficient route determinations.

During the pre-matching batch analysis process 260, the hybrid delivery system 200 can access delivery data indicative of a plurality of delivery attributes for at least a subset of a plurality of delivery services that are available for batch delivery assessment. The subset of delivery services can include a plurality of batchable delivery service requests 160. The hybrid delivery system 200 can access the batchable delivery service requests 160 based on state data for a plurality of delivery service requests received by the hybrid delivery system 200.

The state data for the plurality of delivery service requests can identify a type of delivery service and timing information associated with the delivery service for each of the delivery service requests.

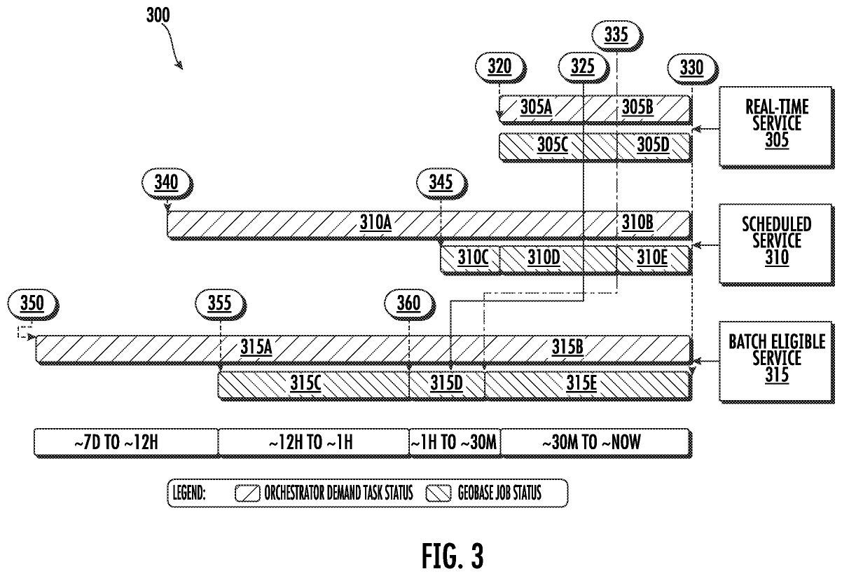

FIG. 3 depicts a state diagram 300 for a delivery service according to example embodiments of the present disclosure. A delivery service can be one of at least three service types including: (i) a real-time service 305; (ii) a scheduled service 310; or (iii) a batchable service 315. Each service type can be associated with one or more different time-based states that are reflective of a respective delivery service's progress within a delivery process stream. A delivery service can be transitioned between states to reflect the current status of the delivery service with respect to tasks that may be performed to facilitate the service.

A real-time service 305 can include a delivery service that is requested to be performed as soon as possible. The real-time service 305, for example, can include delivery services for perishable items such as food items. The real-time service 305 can be associated with a created state 305A, an active state 305B, an assigned state 305C, and an unassigned state 305D. These states are not mutually exclusive. The real-time service 305 can be assigned one or more of the states at any given point before the completion of the real-time service 305.

The real-time service 305 can be created, at 320, in response to a request for the real-time service 305. Upon creation, the real-time service 305 can be assigned at least one of the created state 305A and/or the unassigned state 305D. The real-time service 305 can remain in the created state 305A until the real-time service 305 is offered to one or more couriers, at 325, at which time the real-time service 305 can be assigned an active state 305B. During the active state 305B, the real-time service 305 can be assigned, at 335, to a courier for performance and, in response, can be assigned an assigned state 305C. The real-time service 305 can remain in the active state 305B until the courier completes performance of the real-time service 305.

A scheduled service 310 can include a delivery service that is requested to be performed at a scheduled time after the request for delivery service is received. The scheduled service 310, for example, can include transportation services at a designated time. The scheduled service 310 can be associated with a created state 310A, an active state 310B, a queued state 310C, an unassigned state 310D, and an assigned state 310E. These states are not mutually exclusive. The scheduled service 310 can be assigned one or more of the states at any given point before the completion of the scheduled service 310.

The scheduled service 310 can be created, at 340, in response to a request for the scheduled service 310. Upon creation, the scheduled service 310 can be assigned the created state 310A.

At 345, the scheduled service 310 can be added to a delivery queue and be assigned a queued state 310C. The scheduled service 310 can be added to the delivery queue based on a threshold time before the requested service time. The threshold time can be a predetermined static time period before the requested service time. In addition, or alternatively, the threshold time can be a function of the requested service time, historical courier availability information, and/or any other factor that may contribute to the performance of a delivery service.

The scheduled service 310 can remain in the queued state 310C until the scheduled service 310 is offered to one or more couriers. At 325, the scheduled service 310 can be assigned an active state 310B and/or an unassigned state 310D. During the unassigned state 310D, the scheduled service 310 can be assigned, at 335, to a courier for performance and, in response, can be assigned an assigned state 310E. The scheduled service 310 can remain in the active state 310B until the courier completes performance of the scheduled service 310.

The batch eligible service 315 can include a delivery service that satisfies one or more criteria for a prematching batch process. The criteria, for example, can include scheduled services with: (i) long delivery windows, or (ii) long delivery lead time. The long delivery windows, for example, can include a thirty minute to two hour minimum delivery window to allow flexibility around batching. The long delivery lead time can include a two hour minimum lead time to allow sufficient time for offline planning.

The batch eligible service 315 can be created, at (350), in response to a request for the scheduled service 310 that satisfies the one or more criteria for a prematching batch process. In the event the scheduled service 310 does satisfy the one or more criteria for a prematching batch process, the delivery service can be flagged as a batch eligible service 315. The batch eligible service 315 can be associated with a created state 315A, an active state 315B, a batching state 315C, an unassigned state 315D, or an assigned state 315E. These states are not mutually exclusive. The batch eligible service 315 can be assigned one or more of the states at any given point before the completion of the batch eligible service 315.

Upon creation at 350, the batch eligible service 315 can be assigned the created state 315A.

At 355, the batch eligible service 315 can be selected for batching and be assigned a batching state 315C. The batch eligible service 315 can be selected for batching based on a threshold time before a requested service time. The threshold time can be a predetermined static time period before the requested service time. In addition, or alternatively, the threshold time can be a function of the requested service time, historical courier availability information, or any other factor that may contribute to the performance of a delivery service.

The batch eligible service 315 can remain in the batching state 315C until the batch eligible service 315 is offered to one or more couriers at 360. The batch eligible service 315 can be provided to one or more couriers at the earliest dispatch time available for: (i) the batch eligible service 315 or (ii) another delivery service that is batched with the batch eligible service 315. At 360, route data of a batched route for performing the batch eligible service 315 and the other services batched with the batch eligible service 315 can be provided to one or more couriers. At this time the batched route can be locked and the batch eligible service 315 can be assigned to an unassigned state 315D.

At 325, the batch eligible service 315 can be assigned an active state 315B. During the active state 315B and the unassigned state 315D, the batch eligible service 315 can be assigned, at 335, to a courier for performance and, in response, can be assigned an assigned state 315E. The batch eligible service 315 can remain in the active state 315B until the courier completes performance of the scheduled service 315.

Turning back to FIG. 2, the hybrid delivery system 200 can access the batchable delivery service requests 160 by obtaining delivery service requests of a batch eligible service type that are created and unassigned. For example, the batch manager 205 can access delivery data for the batchable delivery service requests 160 from the memory 265. The batch manager 205 can analyze delivery data for each of the plurality of batchable delivery service requests 160 during the pre-matching batch analysis process 260 to dynamically update a service queue 270 that includes a plurality of precomputed batched routes accounting for each of the plurality of batchable delivery service requests 160.

For example, the batch manager 205 can provide the delivery data for the batchable delivery service requests 160 to a pre-matching batch analysis process 260 to generate a batched route for at least two delivery services of the delivery services that are batch eligible. The batched route can include one or more pick-up locations, a plurality of destination locations, timing information for arriving at the pick-up/drop-off locations, and item characteristics for each of the at least two delivery services of the batched route.

For example, the batched route can include pick-up and drop-off locations for each item of a requested delivery service included in the batched route. Each delivery service can include one or more pick-up/drop-off locations. In some implementations, a delivery service can include one pick-up location and a plurality of drop-off locations. In some implementations, a delivery service can include a plurality of pick-up location and one drop-off locations.

Additionally, the batched route can include timing information for arriving at the pick-up/drop-off locations for the delivery services performed by the batched route. The timing information can include a time period for arriving at each of the pick-up/drop-off locations of the batched route.

As another example, the batched route can include item characteristics for each of the at least two delivery services of the batched route. The item characteristics can include a threshold item capacity that can be descriptive of an aggregate weight, size, or dimensions of the items requested to be transported by the at least two delivery services of the batched route.

In some implementations, the batched route can include a status. The status can indicate whether the batched route can be dispatched or modified. A batched route can have a locked status, for example, indicating that the batched route is unmodifiable and/or is ready to be assigned to a courier. In addition, or alternatively, the batched route can have a modifiable status indicating that the batched route is not ready to be assigned to a courier and can be modified. The status for the batched route can be used to transition the batched route from the pre-matching batch analysis process 260 to the real-time courier matching process 250.

By way of example, the status for the batched route can be changed based on a state change associated with a delivery service of the batched route. For instance, the status for the batched route can change from a modifiable status to a locked status in response to a delivery service's state changing to an unassigned state (e.g., unassigned state 315D of FIG. 3).

The batched route can be generated based on the delivery attributes for the plurality of delivery services. The delivery attributes, for example, can include at least one pick-up location and at least one drop-off location for a respective delivery service. In some implementations, a respective delivery service can include a plurality of pick-up and drop-off locations.

In addition, or alternatively, the plurality of delivery attributes can include item characteristics associated with a respective delivery service. The item characteristics can include a weight, a size, or one or more dimensions for a respective item associated with the delivery service. In some implementations, the plurality of delivery attributes can include a perishability of the respective item associated with the delivery service. Item characteristics can be descriptive of one individual item or an aggregate of several items or each item in a group of items. For example, the item characteristics can be indicative of a total size and shape of a group of food item boxes, when all stacked together. Additionally, or alternatively, the item characteristics can indicate the respective size/shape of an individual box and a number thereof. In some implementations, the item characteristics (e.g., size, shape, etc.) can be descriptors, referential phrases representative of the characteristics (e.g., “T-shirt sized boxes”). In some implementations, the item characteristics can be based on pre-determined stored information. For example, a service provider may have a canonical product catalog of characteristics for items. The catalog can be stored digitally and can be adjustable overtime. The item characteristics can be descriptive of the information in the catalog.

The plurality of delivery attributes can include timing constraints for the batched delivery service. The timing constraints can specify a loading duration that is indicative of a loading time or an unloading time for a respective item associated with the delivery service. In addition, or alternatively, the plurality of delivery attributes can include a delivery time range for the delivery service. In some implementations, the delivery time range can be based on the perishability of the respective item associated with the delivery service.

In some implementations, a delivery time for the batched route can be determined based on the delivery time range and/or the loading duration for the delivery services of the batched route.

The plurality of batched routes of the service queue 270 can be reconfigured during a batched route generator process 210 at a predetermined time interval. For instance, the hybrid delivery system 200 can include a memory 265 storing pending delivery requests for implementation by the hybrid delivery system 200. The memory 265 can include a short term cache memory, a long term secondary memory, etc.

The pending delivery requests can include real-time delivery service requests 145 and batchable delivery service requests 160 that are assigned a respective created state (e.g., created states 305B, 310B, 315B). At the predetermined time interval, the hybrid delivery system 200 can retrieve the pending batchable delivery service requests 160 for a particular area to reconfigure the plurality of batched routes of the service queue 270.

For example, the hybrid delivery system 200 can include a timer 215 that can produce a recurring trigger to kick off the batched route generator process 210. The timer 215, for example, can issue an instruction to the batch manager 205 at a predetermined and/or dynamically determined time interval to initiate the batched route generator process 210. The time interval, for example, can include a thirty minute scan time interval. In some implementations, the timer 215 can dynamically determine the time interval based on a respective geographic area associated with the delivery services, an availability of couriers in the geographic area, a demand for deliveries in the geographic area, or any other characteristics than may impact the computational complexity for generating batched routes that account for the delivery services requested in the geographic area.

The pre-matching batch analysis process 260 can include a batched route generator process 210 that can include a plurality of phases. The phases can include a cost phase 210A, an enumeration phase 210B, and a route phase 210C.

During the cost phase 210A, the hybrid delivery system 200 can determine one or more delivery service groups from the subset of delivery services based on the pick-up locations and drop-off locations for the delivery services. For example, the hybrid delivery system 200 can generate a cost matrix that is descriptive of the time and/or distance values for every location corresponding to each of the batchable delivery services. The hybrid delivery system 200 can generate one or more delivery service groups based on the cost matrix. Each delivery service group can include one or more delivery services that include a pick-up/drop-off time and location that are within a determined distance and/or travel time of one another.

During the enumeration phase 210B, the hybrid delivery system 200 can generate a plurality of candidate routes for the subset of delivery services based on the one or more delivery service groups. For instance, the hybrid delivery system 200 can iteratively determine a plurality of candidate routes for each of the delivery service groups. For example, the hybrid delivery system 200 can use a plurality of heuristics to reduce the number of routes to explore.

The heuristics, for example, can analyze the plurality of delivery attributes to generate a plurality of candidate routes that are feasible and reduce courier time. The heuristics can include a relative route distance threshold, a pick-up/drop-off duration, a threshold item capacity, etc. The heuristics can be used to minimize an aggregate courier time across the batched delivery services to determine the plurality of candidate routes. The candidate routes can be scored based on an amount of courier time saved and a flexibility of adherence to the candidate route.

In some implementations, the heuristics can be used to increase the number of couriers that may perform a batch route. As one example, the hybrid delivery system 200 can determine a threshold item capacity for a delivery service based on an aggregate item weight, item size, and item dimensions for the respective items associated with the delivery service. The hybrid delivery system 200 can generate the batched route based on the threshold item capacity. By way of example, the hybrid delivery system 200 can match different delivery services to reduce the threshold item capacity for the batched route in order to increase the number of couriers that can physically perform the batched route.

During the route phase 210C, the hybrid delivery system 200 can select the batched route from the plurality of candidate routes based on an aggregated driving time associated with one or more combinations of the plurality of candidate routes. The batched route can be assigned a unique identifier and route data for the batched route can be stored to the bridge database 230. The bridge database 230, for example, can include a database that is accessible to both the real-time courier matching process 250 and the pre-matching batch analysis process 260. The unique identifier can be stored in the service queue 270. The unique identifier can be used to retrieve the route data from the bridge database 230.

The hybrid delivery system 200 can update the service queue 270 based on the batched route. For instance, the service queue can include a plurality of precomputed routes associated with the subset of delivery services that were computed during a previous time interval. During a current time interval, the hybrid delivery system 200 can generate, based on the batched route, a plurality of additional batched routes that account for each batchable delivery service of the subset of delivery services. Each of the additional batched routes can be assigned a unique identifier and route data for the batched routes can be stored to the bridge database 230. The service queue 270 can be updated by replacing the plurality of precomputed routes with the unique identifiers of the plurality of batched routes generated during the current time interval.

In some implementations, the hybrid delivery system 200 can determine a delivery time for each of the plurality of batched routes. The delivery time for a respective batched route, for example, can include the earliest requested delivery time for the delivery services of the respective batched route. The hybrid delivery system 200 can update the service queue based on the delivery time for each of the plurality of batched routes by ordering the plurality of batched routes in accordance with the delivery times.

The hybrid delivery system 200 can detect, based on the state data, a state change that is associated with a delivery service associated with the batched route. The state change can include a transition from a created state to an active state. In response to the state change, hybrid delivery system 200 can perform the real-time courier matching process 250 with the batched route.

The real-time courier matching process 250 can include a courier assignment process 225 in which a courier is assigned to perform the batched route. The courier assignment process can include a delivery service phase 225A, a planning phase 225B, and an assignment phase 225C.

During the delivery service phase 225A, the hybrid delivery system 200 can fetch delivery tasks from the assignment manager 220. The assignment manager 220 can receive the delivery tasks from the memory 265 at a short-term time interval (e.g., fifteen seconds, etc.). At each short-term time interval, the assignment manager 220 can receive delivery data for pending real-time delivery service requests 145 and batchable delivery service requests 160. Each delivery task can be indicative of: (i) a delivery service corresponding to a real-time delivery service request 145, (ii) a plurality of delivery services corresponding to a batched route, or (iii) a hybrid combination of a real-time delivery service corresponding to a real-time delivery service request 145 and a plurality of delivery services corresponding to a batched route. During the delivery service phase 225A, the hybrid delivery system 200 can fetch the delivery tasks from the assignment manager 220 that are ready to be assigned to a courier (e.g., include an active status).

During the planning phase 225B, hybrid delivery system 200 can generate full supply plans based on route information stored at the bridge database 230. For example, the hybrid delivery system 200 can access the bridge database 230 to enrich the retrieved delivery tasks. By way of example, each of the delivery tasks can include a unique identifier corresponding to a real-time delivery service and/or a batched route. The hybrid delivery system 200 can retrieve route data for a delivery task by searching the bridge database 230 using a respective unique identifier. When the hybrid delivery system 200 enriches the retrieved delivery tasks, the hybrid delivery system 200 can pull information on whether or not each delivery task is a batched task with a corresponding batched route. For every batched task, the hybrid delivery system 200 can have a flag identifying the task as a batched task. The batched route for a batched task can be modified based on real-time vehicle data and an updated estimated time of arrival for each of the pick-up and drop-off locations of the batched route can be calculated.

During the assignment phase 225C, the hybrid delivery system 200 can match the batched plans to eligible couriers. For example, the hybrid delivery system 200 can access real-time vehicle data indicative of an availability of one or more vehicles within the geographic area. The availability of the one or more vehicles can be based on one or more assignments for the vehicle(s) and/or a capacity of the vehicle(s). For instance, the real-time vehicle data can be indicative of one or more previously and/or concurrently assigned delivery services. In addition, or alternatively, the real-time vehicle data can be indicative of a capacity for the one or more vehicles.

By way of example, the capacity of a vehicle can be based on a vehicle/courier type. The vehicle/courier type can be descriptive of at least one of an automobile, a bicycle, a scooter, or a human. In addition, or alternatively, the vehicle/courier type can be descriptive of a type of automobile (e.g., sedan, coupe, sports-utility vehicle, van, truck, etc.). Each vehicle/courier type can be associated with a respective capacity.

In some implementations, the real-time vehicle data can be indicative of a current driving assignment for a respective vehicle and the capacity of the respective vehicle can be based on the current driving assignment and the vehicle type. For instance, the capacity of the respective vehicle can be the capacity associated with the vehicle type minus the capacity occupied by the items of the current driving assignment.

The hybrid delivery system 200 can communicate, based on the real-time vehicle data, data indicative of the batched route to one or more vehicles during the real-time matching process 225. The data indicative of the batched route can be communicated to each of a subset of vehicles that are available to perform the batched route. In some implementations, the availability of the subset of vehicles can be based on the capacity of the vehicles. For instance, the hybrid delivery system 200 can determine that the capacity of the vehicles accommodates the threshold item capacity for the batched route. The hybrid delivery system 200 can communicate the data indicative of the batched route to the vehicles based on the determination that the capacity of the vehicles accommodates the threshold item capacity for the batched route.

In some implementations, the hybrid delivery system 200 can communicate the data indicative of the batched route through a respective courier interface accessible by an available courier.

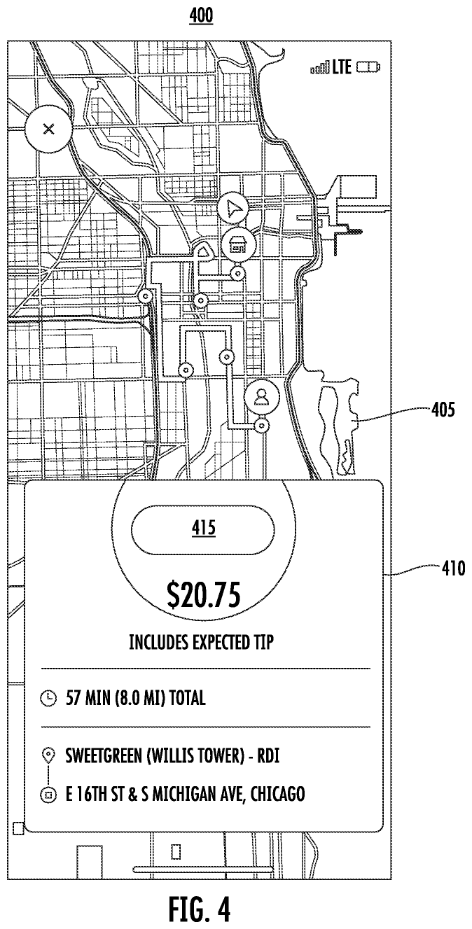

FIG. 4, for example, depicts an interactive user interface 400 according to example embodiments of the present disclosure. The interactive user interface 400 can be presented via a display device of courier device. The interactive user interface 400 can include an interactive map interface 405 and an indication 410 of the batched route. For instance, the hybrid delivery system can generate an indication 410 of the batched route that can be descriptive of an estimated total journey, an earnings potential, and a general route summary for the batched route. The estimated total journey can include an estimated time duration and/or an estimated distance for completing the batched route. The earning potential can include an estimated income for completing the batched route. In some implementations, the estimated income can include a predicted tip amount that is based on historical data. The general route summary can include an initial pick-up location and a final destination location for the batched route.

The indication 410 of the batched route can include an interactive selection widget that can be selectable to allow a courier to offer to perform the batched route. The selection widget can include an interactive timer that can illustrate a time available for selecting the batched route. The courier can select the batched route in order to be assigned the batched route.

Turning back to FIG. 2, in some implementations, the hybrid delivery system 200 can communicate the data indicative of the batched route by modifying a shared data structure accessible to a plurality of couriers via a respective courier interface. For instance, the hybrid delivery system 200 can add the indication of the batched route to an offline delivery board accessible by an available courier (e.g., operator of an available vehicle). The offline delivery board can include a plurality of batched routes that are ready to be assigned to the courier. The offline delivery board can be shared by a plurality of courier such that multiple couriers can simultaneously view the batched routes at the same time.

The indication of the batched route can be selectable (and/or include an interactive widget) by a courier to view additional details. For example, the hybrid delivery system 200 can receive data indicative of a selection of the batched route by a courier (e.g., an operator of an available vehicle). In response to the selection, the hybrid delivery system 200 can communicate additional route data for the selected batched route to the courier.

The route data for the batched route can be descriptive of: (i) a respective drop-off and pick-up location for each of the at least two delivery services of the batched route, (ii) an order for arriving at the respective drop-off and pick-up location for each of the at least two delivery services of the batched route, (iii) a route between the respective drop-off and pick-up location for each of the at least two delivery services of the batched route, or (iv) timing information for a performance of each of the at least two delivery services of the batched route.

In some implementations, the route data can be displayed, in response to the selection of the batched route, to the courier via an interactive map interface. By way of example, the interactive map interface can depict the batched route and can include an interactive widget for each pick-up and drop-off location of the batched route. A widget can be selectable to provide pick-up/drop-off information for a respective location such as, for example, an estimated loading/unloading duration, a weight, size, or one or more dimensions for a respective item to be loaded/unloaded, an estimated time of arrival at the respective location, etc.

In some implementations, the data indicative of the batched route can be abstracted out and constructed or modified while the courier performs the batched route. For example, the abstracted batched route can include an estimated final destination and a next stop. The next stop can be modifiable to incorporate real-time delivery services to different portions of the batched route. For example, the batched route can be modified to add an additional pick-up location to service a recently received real-time delivery service request. In this manner, the batched route can be combined with real-time service requests to improve courier efficiency.

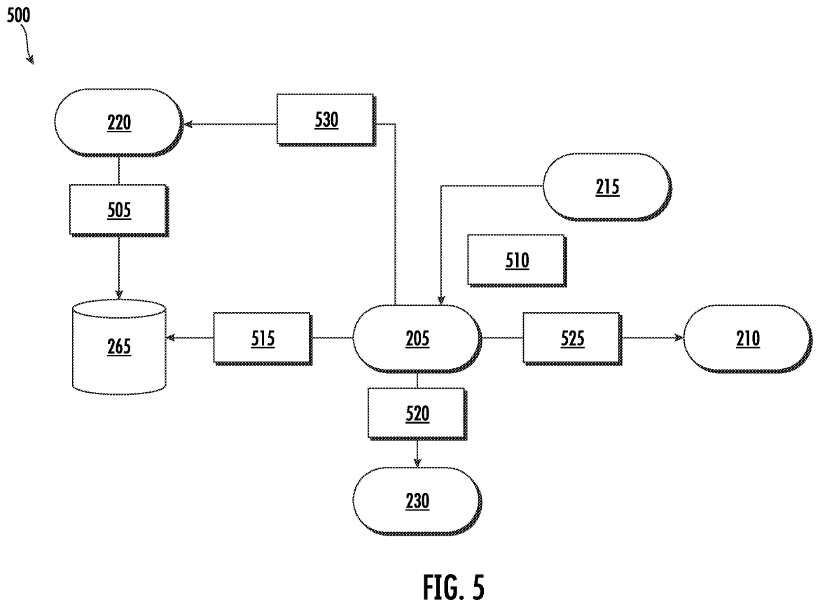

FIG. 5 depicts a data flow diagram 500 for the hybrid delivery system 200 according to aspects of the present disclosure. The data flow diagram 500 depicts a plurality of subsystems and processes of the hybrid delivery system 200 that are configured to generate a batched route and assign a precomputed batched route to a courier in real-time. For instance, the data flow diagram can illustrate the movement of data between the service queue 270, the batched route generator process 210, timer 215, the assignment manager 220, the bridge database 230, and the memory 265.

At 505, the assignment manager 220 can input a delivery task to the memory 265. The delivery task can be input to the memory 265 in response to a delivery service request. The assignment manager 220 can analyze the delivery service request to generate one or more flags for the delivery task that are indicative of a state for the requested delivery service. The flags, for example, can indicate whether the delivery task includes a batch eligible service. The assignment manager 220 can input the delivery task to the memory 265 with the one or more flags for the delivery task.

The assignment manager 220 can be an entry point for delivery service requests to the hybrid delivery system 200. The assignment manager 220 can generate a delivery task for each delivery service request that represents a delivery service requested by the delivery service request. Each delivery task can be assigned a flag that indicates whether the delivery task satisfies one or more criteria (e.g., has a sufficient delivery lead time, is not perishable, etc.) for batch analysis. The flagged delivery task can then be stored in the memory 265. The flagged delivery task can be removed/deleted from the memory 265 and/or moved to an active status in the memory 265 after the delivery task is assigned to a courier for performance. In this manner, the memory 265 can include a real-time snapshot of the delivery tasks for the hybrid delivery system.

At 510, the timer 215 can communicate an instruction to update the service queue 270 that includes a plurality of precomputed routes accounting for the plurality of delivery tasks that are flagged for batch analysis. The instruction can trigger the batch manager 205 to initiate the pre-matching batch analysis process for the flagged delivery tasks stored in the memory 265.

At 515, the batch manager 205 can communicate a query to the memory 265 to retrieve each of the flagged delivery tasks stored in the memory 265. For example, each of the delivery tasks stored in the memory 265 can include a unique identifier corresponding to the delivery task. At 515, the batch manager 205 can retrieve a list of unique identifiers that identify each of the delivery tasks that are flagged as a batch eligible service.

At 520, the batch manager 205 can issue a query to the bridge database 230 to retrieve delivery data for each of the delivery tasks identified by a list of unique identifiers. For each unique identifier, the batch manager 205 can query delivery data for the corresponding delivery service. The delivery data, for example, can include a pick-up/drop-off location, etc.

At 525, the batch manager 205 can provide the delivery data to the batched route generator process 210 and receive, as an output of the batched route generator process 210, a plurality of batched routes that accommodate each of the flagged delivery services.

At 530, the batch manager can provide the plurality of batched routes to the assignment manager 220. The assignment manager 220 can update the plurality of delivery tasks based on the plurality of batched routes. For example, the assignment manager 220 can generate aggregate delivery tasks for a plurality of delivery tasks that are performed by a respective batched route. In this manner, a plurality of delivery services can be grouped into one aggregate delivery task.

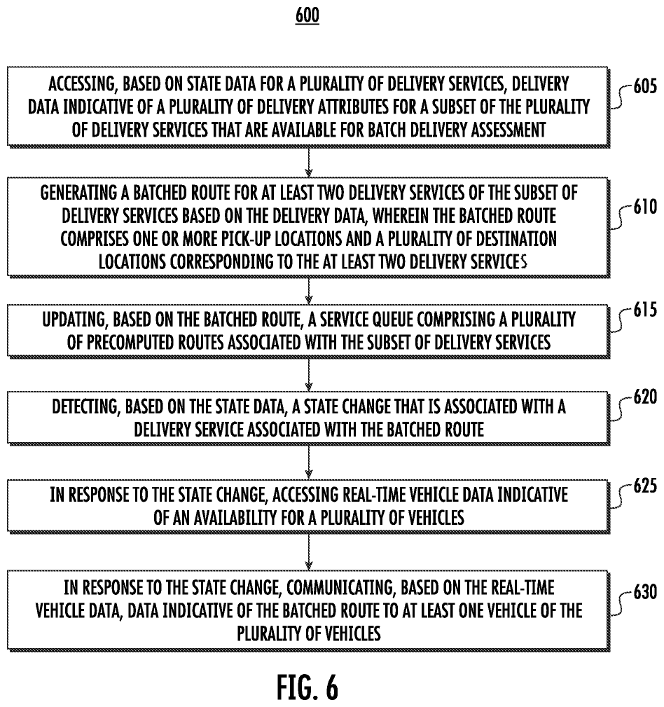

FIG. 6 depicts a flowchart diagram of an example method 600 for a hybrid delivery service according to example embodiments of the present disclosure. One or more portion(s) of the method 600 can be implemented by one or more computing devices such as, for example, the computing devices/systems described in FIGS. 1-2, 4-5, and/or 9-10. Moreover, one or more portion(s) of the method 600 can be implemented as an algorithm on the hardware components of the device(s) described herein (e.g., as in FIGS. 1-2, 4-5, and/or 9-10). For example, a computing system can include one or more processors and one or more non-transitory, computer-readable media storing instructions that are executable by the one or more processors to cause the computing system to perform operations, the operations including one or more of the operations/portions of method 600. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (605), the method 600 can include accessing, based on state data for a plurality of delivery services, delivery data indicative of a plurality of delivery attributes for a subset of the plurality of delivery services that are available for batch delivery assessment. For instance, a computing system (e.g., an operations computing system associated with a service entity) can access, based on the state data for the plurality of delivery services, the delivery data indicative of the plurality of delivery attributes for the subset of the plurality of delivery services that are available for batch delivery assessment.

As described herein, the plurality of delivery attributes can include a pick-up location and a drop-off location for each delivery service. In some implementations, the plurality of delivery attributes can include a weight, a size, or one or more dimensions for each respective item associated with each delivery service. In addition, or alternatively, the plurality of delivery attributes can include a loading duration that is indicative of a loading time or an unloading time for each respective item associated with each delivery service. In some implementations, the plurality of delivery attributes can include a delivery time range for each delivery service.

At (610), the method 600 can include generating a batched route for at least two delivery services of the subset of delivery services based on the delivery data. For instance, a computing system (e.g., an operations computing system associated with a service entity) can generate a batched route for the at least two delivery services of the subset of delivery services based on the delivery data. The batched route can include one or more pick-up locations and a plurality of destination locations corresponding to the at least two delivery services.

At (615), the method 600 can include updating, based on the batched route, a service queue including a plurality of precomputed routes associated with the subset of delivery services. For instance, a computing system (e.g., an operations computing system associated with a service entity) can update, based on the batched route, the service queue including the plurality of precomputed routes associated with the subset of delivery services.

At (620), the method 600 can include detecting, based on the state data, a state change that is associated with a delivery service of the subset of delivery services. For instance, a computing system (e.g., an operations computing system associated with a service entity) can detect, based on the state data, the state change that is associated with the delivery service of the subset of delivery services.

At (625), the method 600 can include, in response to the state change, accessing real-time vehicle data indicative of an availability for a plurality of vehicles. For instance, a computing system (e.g., an operations computing system associated with a service entity) can, in response to the state change, access the real-time vehicle data indicative of the availability for the plurality of vehicles.

At (630), the method 600 can include, in response to the state change, communicating, based on the real-time vehicle data, data indicative of the batched route to at least one vehicle of the plurality of vehicles. For instance, a computing system (e.g., an operations computing system associated with a service entity) can, in response to the state change, communicate, based on the real-time vehicle data, data indicative of the batched route to at least one vehicle of the plurality of vehicles.

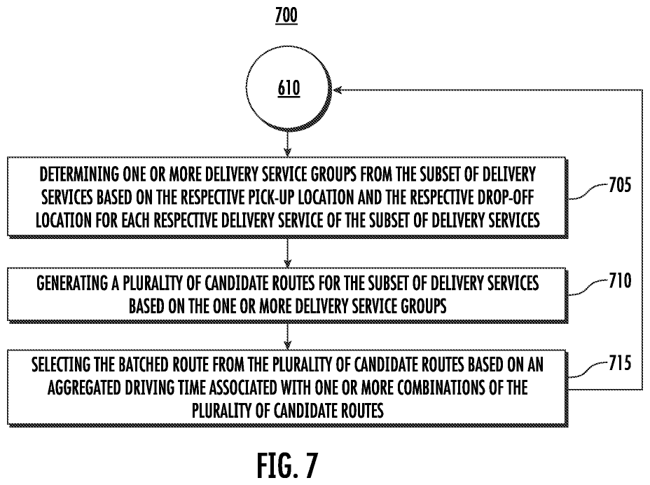

FIG. 7 depicts a flowchart diagram of an example method 700 for a hybrid delivery service according to example embodiments of the present disclosure. One or more portion(s) of the method 700 can be implemented by one or more computing devices such as, for example, the computing devices/systems described in FIGS. 1-2, 4-5, and/or 9-10. Moreover, one or more portion(s) of the method 700 can be implemented as an algorithm on the hardware components of the device(s) described herein (e.g., as in FIGS. 1-2, 4-5, and/or 9-10). For example, a computing system can include one or more processors and one or more non-transitory, computer-readable media storing instructions that are executable by the one or more processors to cause the computing system to perform operations, the operations including one or more of the operations/portions of method 700. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

The method 700 can include one or more suboperations of operation 610 in which the computing system generates a batched route for at least two delivery services of the subset of delivery services based on the delivery data.

At (705), the method 700 can include determining one or more delivery service groups from the subset of delivery services based on the respective pick-up location and the respective drop-off location for each respective delivery service of the subset of delivery services. For instance, the computing system (e.g., an operations computing system associated with a service entity) can determine one or more delivery service groups from the subset of delivery services based on the respective pick-up location and the respective drop-off location for each respective delivery service of the subset of delivery services.

At (710), the method can include generating a plurality of candidate routes for the subset of delivery services based on the one or more delivery service groups. For instance, the computing system (e.g., an operations computing system associated with a service entity) can generate the plurality of candidate routes for the subset of delivery services based on the one or more delivery service groups.

At (715), the method can include selecting the batched route from the plurality of candidate routes based on an aggregated driving time associated with one or more combinations of the plurality of candidate routes. For instance, the computing system (e.g., an operations computing system associated with a service entity) can select the batched route from the plurality of candidate routes based on the aggregated driving time associated with one or more combinations of the plurality of candidate routes.

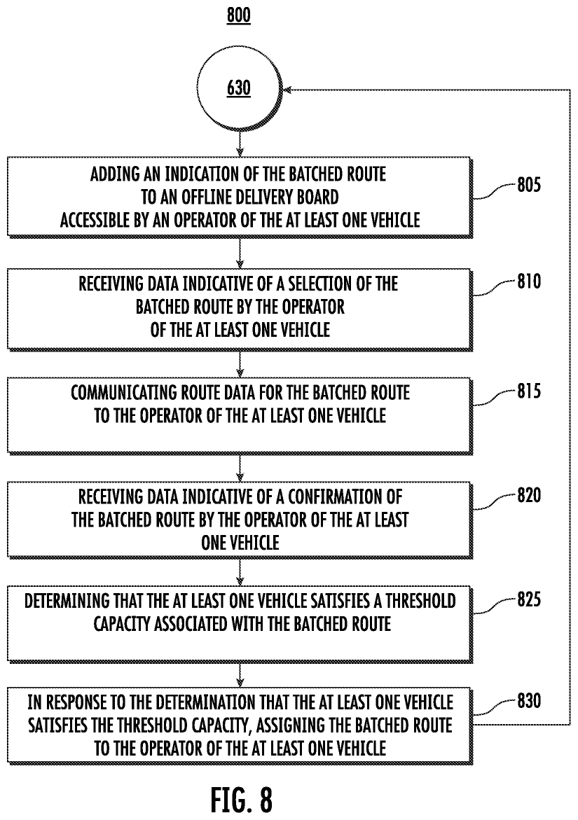

FIG. 8 depicts a flowchart diagram of an example method 800 for a hybrid delivery service according to example embodiments of the present disclosure. One or more portion(s) of the method 800 can be implemented by one or more computing devices such as, for example, the computing devices/systems described in FIGS. 1-2, 4-5, and/or 9-10. Moreover, one or more portion(s) of the method 800 can be implemented as an algorithm on the hardware components of the device(s) described herein (e.g., as in FIGS. 1-2, 4-5, and/or 9-10). For example, a computing system can include one or more processors and one or more non-transitory, computer-readable media storing instructions that are executable by the one or more processors to cause the computing system to perform operations, the operations including one or more of the operations/portions of method 800. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

The method 800 can include one or more suboperations of operation 630 in which the computing system communicates, based on the real-time vehicle data, data indicative of the batched route to at least one vehicle of the plurality of vehicles.

At (805), the method 800 can include adding an indication of the batched route to an offline delivery board accessible by an operator of the at least one vehicle. For instance, the computing system (e.g., an operations computing system associated with a service entity) can add an indication of the batched route to the offline delivery board accessible by the operator of the at least one vehicle.

At (810), the method 800 can include receiving data indicative of a selection of the batched route by the operator of the at least one vehicle. For instance, the computing system (e.g., an operations computing system associated with a service entity) can receive the data indicative of the selection of the batched route by the operator of the at least one vehicle.

At (815), the method 800 can include communicating route data for the batched route to the operator of the at least one vehicle. For instance, the computing system (e.g., an operations computing system associated with a service entity) can communicate route data for the batched route to the operator of the at least one vehicle.

At (820), the method 800 can include receiving data indicative of a confirmation of the batched route by the operator of the at least one vehicle. For instance, the computing system (e.g., an operations computing system associated with a service entity) can receive data indicative of a confirmation of the batched route by the operator of the at least one vehicle.

At (825), the method 800 can include determining that the at least one vehicle satisfies a threshold capacity associated with the batched route. For instance, the computing system (e.g., an operations computing system associated with a service entity) can determine that the at least one vehicle satisfies a threshold capacity associated with the batched route.

At (830), the method 800 can include, in response to the determination that the at least one vehicle satisfies the threshold capacity, assigning the batched route to the operator of the at least one vehicle. For instance, the computing system (e.g., an operations computing system associated with a service entity) can, in response to the determination that the at least one vehicle satisfies the threshold capacity, assign the batched route to the operator of the at least one vehicle.

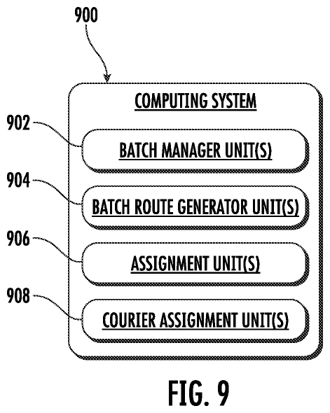

Various means can be configured to perform the methods and processes described herein. For example, FIG. 9 depicts an example system 900 that includes various means according to example embodiments of the present disclosure. The computing system 900 can be and/or otherwise include, for example, an operations computing system, etc. The computing system 900 can include data batch manager unit(s) 902, batch route generator unit(s) 904, assignment unit(s) 906, courier assignment unit(s) 908, and/or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., batch manager unit(s) 902) can be configured to access, based on state data for a plurality of delivery services, delivery data indicative of a plurality of delivery attributes for at least a subset of the plurality of delivery services that are available for batch delivery assessment.

In addition, the means (e.g., batch route generator unit(s) 904) can be configured to generate a batched route for at least two delivery services of the subset of delivery services based on the delivery data. The batched route can include one or more pick-up locations and a plurality of destination locations corresponding to the at least two delivery services.

In some implementations, the means (e.g., the batch manager unit(s) 902) can update, based on the batched route, a service queue comprising a plurality of precomputed routes associated with the subset of delivery services.

The means (e.g., assignment unit(s) 906) can be configured to detect, based on the state data, a state change that is associated with a delivery service associated with the batched route.

The means (e.g., courier assignment unit(s) 908) can be configured to, in response to the state change, access real-time vehicle data indicative of an availability of one or more vehicles. In addition, or alternatively, the means (e.g., courier assignment unit(s) 908) can be configured to communicate, based on the real-time vehicle data, data indicative of the batched route to at least one vehicle of the plurality of vehicles.

These described functions of the means are provided as examples and are not meant to be limiting. The means can be configured for performing any of the operations and functions described herein.

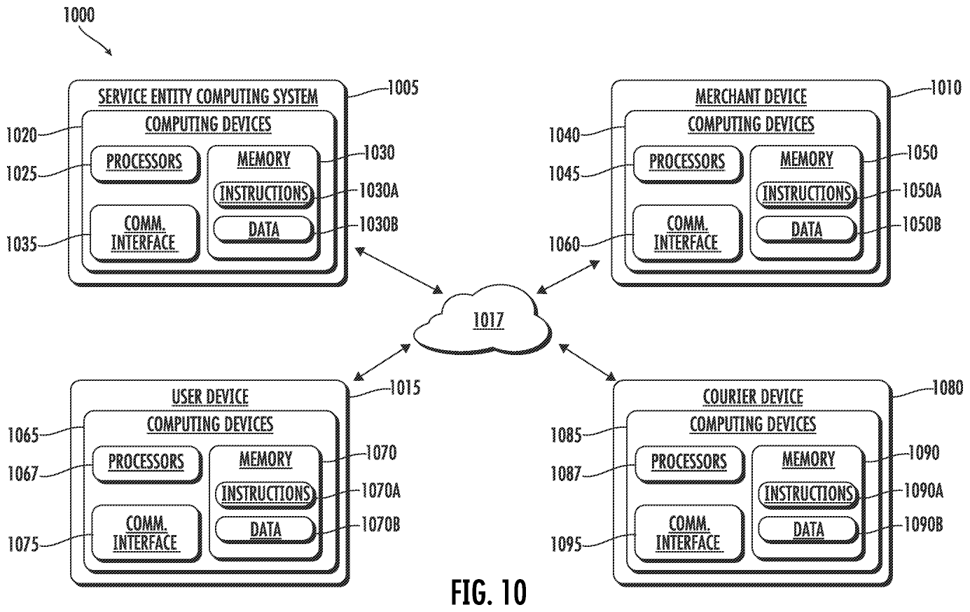

FIG. 10 depicts a block diagram of an example system 1000 for implementing systems and methods according to example embodiments of the present disclosure. The example system 1000 illustrated in FIG. 10 is provided as an example only. The components, systems, connections, and/or other aspects illustrated in FIG. 10 are optional and are provided as examples of what is possible, but not required, to implement the present disclosure. The example system 1000 can include a service entity computing system 1005 (e.g., that is associated with a delivery service entity). The example system 1000 can include one or more merchant devices 1010 (e.g., that is associated with a merchant). The example system 1000 can include one or more user devices 1015 (e.g., user device of the user, user device of the operator, user device of the vehicle). The example system 1000 can include one or more courier devices (e.g., a display device positioned on the exterior of a vehicle). One or more of the service entity computing system 1005, the merchant device 1010, the user device 1015, or the courier device can be communicatively coupled to one another over one or more communication network(s) 1017. The networks 1017 can correspond to any of the networks described herein.

The computing device(s) 1020 of the service entity computing system 1005 can include processor(s) 1025 and a memory 1030. The one or more processors 1025 can be any suitable processing device (e.g., a processor core, a microprocessor, an ASIC, a FPGA, a controller, a microcontroller) and can be one processor or a plurality of processors that are operatively connected. The memory 1030 can include one or more non-transitory computer-readable storage media, such as RAM, ROM, EEPROM, EPROM, one or more memory devices, flash memory devices, data registrar, etc., and combinations thereof.

The memory 1030 can store information that can be accessed by the one or more processors 1025. For example, the memory 1030 (e.g., one or more non-transitory computer-readable storage mediums, memory devices) can include computer-readable instructions 1030A that can be executed by the one or more processors 1025. The instructions 1030A can be software written in any suitable programming language or can be implemented in hardware. Additionally, or alternatively, the instructions 1030A can be executed in logically and/or virtually separate threads on processor(s) 1025.

For example, the memory 1030 can store instructions 1030A that when executed by the one or more processors 1025 cause the one or more processors 1025 (the service entity computing system 1005) to perform operations such as any of the operations and functions of the computing system(s) (e.g., operations computing system) described herein (or for which the system(s) are configured), one or more of the operations and functions for communicating between the computing systems, one or more portions/operations of method 900, and/or one or more of the other operations and functions of the computing systems described herein.

The memory 1030 can store data 1030B that can be obtained (e.g., acquired, received, retrieved, accessed, created, stored). The data 1030B can include, for example, any of the data/information described herein. In some implementations, the computing device(s) 1320 can obtain data from one or more memories that are remote from the service entity computing system 1305.

The computing device(s) 1020 can also include a communication interface 1035 used to communicate with one or more other system(s) remote from the service entity computing system 1005, such as merchant device 1010, user device 1015, and/or courier device 1080. The communication interface 1035 can include any circuits, components, software, etc. for communicating via one or more networks (e.g., network(s) 1017). The communication interface 1035 can include, for example, one or more of a communications controller, receiver, transceiver, transmitter, port, conductors, software and/or hardware for communicating data.

The merchant device 1010 can include one or more computing device(s) 1040 that are remote from the service entity computing system 1005, the user device 1015, and the courier device 1080. The computing device(s) 1040 can include one or more processors 1045 and a memory 1050. The one or more processors 1045 can be any suitable processing device (e.g., a processor core, a microprocessor, an ASIC, a FPGA, a controller, a microcontroller) and can be one processor or a plurality of processors that are operatively connected. The memory 1050 can include one or more tangible, non-transitory computer-readable storage media, such as RAM, ROM, EEPROM, EPROM, one or more memory devices, flash memory devices, data registrar, etc., and combinations thereof.

The memory 1050 can store information that can be accessed by the one or more processors 1045. For example, the memory 1050 (e.g., one or more tangible, non-transitory computer-readable storage media, one or more memory devices) can include computer-readable instructions 1050A that can be executed by the one or more processors 1045. The instructions 1050A can be software written in any suitable programming language or can be implemented in hardware. Additionally, or alternatively, the instructions 1050A can be executed in logically and/or virtually separate threads on processor(s) 1045.

For example, the memory 1050 can store instructions 1050A that when executed by the one or more processors 1045 cause the one or more processors 1045 to perform operations such as any of the operations and functions of the computing system(s) (e.g., merchant server) described herein (or for which the system(s) are configured), one or more of the operations and functions for communicating between computing systems, one or more portions/operations of method 900, and/or one or more of the other operations and functions of the computing systems described herein. The memory 1050 can store data 1050B that can be obtained. The data 1050B can include, for example, any of the data/information described herein.

The computing device(s) 1040 can also include a communication interface 1060 used to communicate with one or more system(s) that are remote from the merchant device 1010. The communication interface 1060 can include any circuits, components, software, etc. for communicating via one or more networks (e.g., network(s) 1017). The communication interface 1060 can include, for example, one or more of a communications controller, receiver, transceiver, transmitter, port, conductors, software and/or hardware for communicating data.

The user device 1015 can include one or more computing device(s) 1065 that are remote from the service entity computing system 1005, the merchant device 1010, and the courier device 1080. The computing device(s) 1065 can include one or more processors 1067 and a memory 1070. The one or more processors 1067 can be any suitable processing device (e.g., a processor core, a microprocessor, an ASIC, a FPGA, a controller, a microcontroller) and can be one processor or a plurality of processors that are operatively connected. The memory 1070 can include one or more tangible, non-transitory computer-readable storage media, such as RAM, ROM, EEPROM, EPROM, one or more memory devices, flash memory devices, data registrar, etc., and combinations thereof.

The memory 1070 can store information that can be accessed by the one or more processors 1067. For example, the memory 1070 (e.g., one or more tangible, non-transitory computer-readable storage media, one or more memory devices) can include computer-readable instructions 1070A that can be executed by the one or more processors 1067. The instructions 1070A can be software written in any suitable programming language or can be implemented in hardware. Additionally, or alternatively, the instructions 1070A can be executed in logically and/or virtually separate threads on processor(s) 1067.

For example, the memory 1070 can store instructions 1070A that when executed by the one or more processors 1067 cause the one or more processors 1067 to perform operations such as any of the operations and functions of the computing system(s) (e.g., user devices) described herein (or for which the user device(s) are configured), one or more of the operations and functions for communicating between systems, one or more portions/operations of method 900, and/or one or more of the other operations and functions of the computing systems described herein. The memory 1070 can store data 1070B that can be obtained. The data 1070B can include, for example, any of the data/information described herein.

The computing device(s) 1065 can also include a communication interface 1075 used to communicate computing device/system that is remote from the user device 1015, such as merchant device 1010, service entity computing system 1005, or courier device 1080. The communication interface 1075 can include any circuits, components, software, etc. for communicating via one or more networks (e.g., network(s) 1017). The communication interface 1075 can include, for example, one or more of a communications controller, receiver, transceiver, transmitter, port, conductors, software and/or hardware for communicating data.

The computing device(s) 1085 of the courier device 1080 can include processor(s) 1087 and a memory 1090. The one or more processors 1087 can be any suitable processing device (e.g., a processor core, a microprocessor, an ASIC, a FPGA, a controller, a microcontroller) and can be one processor or a plurality of processors that are operatively connected. The memory 1090 can include one or more non-transitory computer-readable storage media, such as RAM, ROM, EEPROM, EPROM, one or more memory devices, flash memory devices, data registrar, etc., and combinations thereof.

The memory 1090 can store information that can be accessed by the one or more processors 1087. For example, the memory 1090 (e.g., one or more non-transitory computer-readable storage mediums, memory devices) can include computer-readable instructions 1090A that can be executed by the one or more processors 1087. The instructions 1090A can be software written in any suitable programming language or can be implemented in hardware. Additionally, or alternatively, the instructions 1090A can be executed in logically and/or virtually separate threads on processor(s) 1087.

For example, the memory 1090 can store instructions 1090A that when executed by the one or more processors 1087 cause the one or more processors 1087 (the courier device 1080) to perform operations such as any of the operations and functions of the display device(s) described herein (or for which such devices are configured), one or more of the operations and functions for communicating between the computing systems/devices, one or more portions/operations of method 900, and/or one or more of the other operations and functions of the computing systems described herein.

The memory 1090 can store data 1090B that can be obtained (e.g., acquired, received, retrieved, accessed, created, stored). The data 1090B can include, for example, any of the data/information described herein. In some implementations, the computing device(s) 1085 can obtain data from one or more memories that are remote from the courier device 1080.

The computing device(s) 1085 can also include a communication interface 1095 used to communicate with one or more other system(s) remote from the courier device 1080, such as merchant device 1010, user device 1015, and/or service entity computing system 1005. The communication interface 1095 can include any circuits, components, software, etc. for communicating via one or more networks (e.g., network(s) 1017). The communication interface 1095 can include, for example, one or more of a communications controller, receiver, transceiver, transmitter, port, conductors, software and/or hardware for communicating data.

The network(s) 1017 can be any type of network or combination of networks that allows for communication between devices. In some implementations, the network(s) 1017 can include one or more of a local area network, wide area network, the Internet, secure network, cellular network, mesh network, peer-to-peer communication link and/or some combination thereof and can include any number of wired or wireless links. Communication over the network(s) 1017 can be accomplished, for example, via a communication interface using any type of protocol, protection scheme, encoding, format, packaging, etc.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, refers to “and/or”, “at least one of”, or “any combination of” example elements listed therein. Also, terms such as “based on” should be understood as “based at least in part on”.

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and is not meant to be limiting.

What is claimed is:

1. A computing system comprising:
one or more processors; and
one or more tangible, non-transitory, computer-readable media that store instructions that are executable by the one or more processors to cause the computing system to perform operations, the operations comprising:
accessing, based on state data for a plurality of delivery services, delivery data indicative of a plurality of delivery attributes for at least a subset of the plurality of delivery services that are available for batch delivery assessment;
generating a batched route for at least two delivery services of the subset of delivery services based on the delivery data, wherein the batched route comprises one or more pick-up locations and a plurality of destination locations corresponding to the at least two delivery services;
updating, based on the batched route, a service queue comprising a plurality of precomputed routes associated with the subset of delivery services;
detecting, based on the state data, a state change that is associated with a delivery service associated with the batched route; and
in response to the state change:
accessing real-time vehicle data indicative of an availability of one or more vehicles; and
communicating, based on the real-time vehicle data, data indicative of the batched route to at least one vehicle of the plurality of vehicles.

2. The computing system of claim 1, wherein the plurality of delivery attributes comprise a pick-up location and a drop-off location for the delivery service, and wherein generating the batched route for the at least two delivery services based on the delivery data comprises:
determining one or more delivery service groups from the subset of delivery services based on the pick-up location and the drop-off location for the delivery service;
generating a plurality of candidate routes for the subset of delivery services based on the one or more delivery service groups; and
selecting the batched route from the plurality of candidate routes based on an aggregated driving time associated with one or more combinations of the plurality of candidate routes.

3. The computing system of claim 1, wherein the plurality of delivery attributes comprise a weight, a size, and one or more dimensions for a respective item associated with the delivery service, and wherein generating the batched route for the at least two delivery services based on the delivery data comprises:
determining a threshold item capacity for the delivery service based on an aggregate item weight, item size, and item dimensions for the respective item associated with the delivery service; and
generating the batched route based on the threshold item capacity.

4. The computing system of claim 3, wherein the real-time vehicle data is indicative of a capacity of the at least one vehicle, and wherein communicating, based on the real-time vehicle data, the data indicative of the batched route to the at least one vehicle comprises:
determining that the capacity of the at least one vehicle accommodates the threshold item capacity for the at least two delivery services.

5. The computing system of claim 4, wherein the capacity of the at least one vehicle is based on a vehicle type of the at least one vehicle, the vehicle type descriptive of at least one of an automobile, a bicycle, or a human.

6. The computing system of claim 5, wherein the real-time vehicle data is indicative of a current driving assignment for the at least one vehicle, wherein the capacity of the at least one vehicle is based on the current driving assignment.

7. The computing system of claim 1, wherein the plurality of delivery attributes comprise a loading duration that is indicative of a loading time or an unloading time for the respective item associated with the delivery service.

8. The computing system of claim 7, wherein the state change is initiated based on a delivery time associated with the batched route, wherein the delivery time is based on the loading duration for the respective item associated with the delivery service.

9. The computing system of claim 8, wherein the plurality of delivery attributes comprise a delivery time range for the delivery service, and wherein the one or more operations further comprise:
determining the delivery time for the batched route based on the delivery time range and the loading duration for the delivery service.

10. The computing system of claim 8, wherein the plurality of delivery attributes comprise a perishability of the respective item associated with the delivery service, wherein the delivery time range is based on the perishability of the respective item associated with the delivery service.

11. The computing system of claim 1, wherein updating, based on the batched route, the service queue comprising the plurality of precomputed routes associated with the subset of delivery services comprises:
generating, based on the batched route, a plurality of batched routes that account for each of the subset of delivery services; and
updating the service queue with the plurality of batched routes.

12. The computing system of claim 11, wherein the plurality of batched routes are reconfigured at a predetermined time interval.

13. The computing system of claim 11, wherein updating, based on the batched route, the service queue comprising the plurality of precomputed routes associated with the subset of delivery services further comprises:
determining a delivery time for each of the plurality of batched routes; and
updating the service queue based on the delivery time for each of the plurality of batched routes.

14. A method comprising:
accessing, based on state data for a plurality of delivery services, delivery data indicative of a plurality of delivery attributes for at least a subset of the plurality of delivery services that are available for batch delivery assessment;
generating a batched route for at least two delivery services of the subset of delivery services based on the delivery data, wherein the batched route comprises one or more pick-up locations and a plurality of destination locations corresponding to the at least two delivery services;
updating, based on the batched route, a service queue comprising a plurality of precomputed routes associated with the subset of delivery services;
detecting, based on the state data, a state change that is associated with a delivery service associated with the batched route; and
in response to the state change:
accessing real-time vehicle data indicative of an availability of one or more vehicles; and
communicating, based on the real-time vehicle data, data indicative of the batched route to at least one vehicle of the plurality of vehicles.

15. The method of claim 13, wherein communicating, based on the real-time vehicle data, data indicative of the batched route to the at least one vehicle comprises:
adding an indication of the batched route to an offline delivery board accessible by an operator of the at least one vehicle;
receiving data indicative of a selection of the batched route by the operator of the at least one vehicle; and
communicating route data for the batched route to the operator of the at least one vehicle.

16. The method of claim 14, wherein the indication of the batched route is descriptive of an estimated total time, an earnings, and a general route summary.

17. The method of claim 15, wherein the route data for the batched route is descriptive of (i) a respective drop-off and a pick-up location for each of the at least two delivery services of the batched route, (ii) an order for arriving at the respective drop-off and pick-up location for each of the at least two delivery services of the batched route, (iii) a route between the respective drop-off and pick-up location for each of the at least two delivery services of the batched route, and (iv) a timing for a performance of each of the at least two delivery services of the batched route.

18. The method of claim 17, wherein the route data is displayed, in response to the selection of the batched route, to the operator of the at least one vehicle via an interactive map interface.

19. The method of claim 14, wherein the real-time vehicle data is indicative of a subset of vehicles that are associated with a real-time delivery service, and wherein the data indicative of the batched route is communicated to each of the subset of vehicles.

20. One or more non-transitory computer readable media storing instructions that are executable by one or more processors to perform operations comprising:
accessing, based on state data for a plurality of delivery services, delivery data indicative of a plurality of delivery attributes for at least a subset of the plurality of delivery services that are available for batch delivery assessment;
generating a batched route for at least two delivery services of the subset of delivery services based on the delivery data, wherein the batched route comprises one or more pick-up locations and a plurality of destination locations corresponding to the at least two delivery services;
updating, based on the batched route, a service queue comprising a plurality of precomputed routes associated with the subset of delivery services;
detecting, based on the state data, a state change that is associated with a delivery service associated with the batched route; and
in response to the state change:
accessing real-time vehicle data indicative of an availability of one or more vehicles; and
communicating, based on the real-time vehicle data, data indicative of the batched route to at least one vehicle of the plurality of vehicles.
